(19) United States
(12) Patent Application Publication
(10) Pub. No.: US 2026/0204567 A1
(43) Pub. Date: Jul. 16, 2026

(54) CATHODE FOR PROTON BATTERIES AND METHOD OF MANUFACTURE

(71) Applicant: PROTON SYSTEMS PTY LIMITED, Malaga, Western Australia (AU)

(72) Inventors: Bjorn WINTHER-JENSEN, Scarborough, WA (AU); Bartlomiej KOLODZIEJCZVK, Hadfield, VIC (AU); Michael MASTERMAN, Sydney, NSW (AU)

(21) Appl. No.: 19/133,675

(22) PCT Filed: Dec. 7, 2023
(86) PCT No.: PCT/AU2023/051268

§ 371 Date: May 28, 2025

(30) Foreign Application Priority Data
Dec. 7, 2022 (AU) 2022903744

(51) Int. Cl. H01M 4/58; H01M 4/02; H01M 4/04; H01M 4/136; H01M 4/1397; H01M 4/62

(52) U.S. Cl. CPC H01M 4/5825; H01M 4/0404; H01M 4/043; H01M 4/136; H01M 4/1397; H01M 4/623; H01M 4/625; H01M 2004/028

(57) ABSTRACT

The present invention provides a cathode for a proton battery comprising Prussian blue analogues and a method for manufacturing a cathode for a proton battery, the method comprising the steps of forming a slurry comprising Prussian blue analogues, battery-grade carbon nanoparticles and a binder, and coating a layer of the slurry onto a cathode current collector to form the cathode.

### FIELD OF INVENTION

The present invention relates to the field of battery technology and methods of manufacturing batteries.

In one form, the invention relates to cathodes for proton batteries and their method of manufacture.

It will be convenient to hereinafter describe the cathode of the invention in relation to copper and manganese Prussian blue analogues, however it should be appreciated that the present invention is not limited to those species only and extends to a broader range of Prussian blue analogues.

### BACKGROUND ART

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

Lithium-ion batteries are widely used and are one of the most popular types of rechargeable batteries. Compared with traditional battery technology, lithium-ion batteries charge faster, last longer and have high power density and longer battery life. Lithium-ion batteries are produced commercially on a large scale and have good specific density and energy density.

However, lithium-ion batteries have several drawbacks. Their typical life cycle is about three to five years or 500 to 1,000 charge cycles, and they charge at low charge rates, typically between 0.5C and 1C, meaning that the average charging time is at least one to three hours. Lithium and other metals used in lithium-ion batteries, including cobalt and nickel, are becoming increasingly expensive. Furthermore, most parts of a lithium-ion battery are hardly recyclable. They experience safety problems and they sometimes suffer from self-ignition.

A number of considerations have driven the search for new battery chemistries to address the shortcomings of lithium-ion technology. These include factors such as the growing prices for lithium, cobalt, and nickel and increased emphasis on safety, environmental and technical issues. Several new battery chemistries have been proposed, including sodium-ion, vanadium redox flow batteries, zinc bromide batteries, iron-air batteries, and sodium-sulfur batteries.

One of the more recent additions to this growing battery technology is the proton battery. A proton battery is a reversible proton exchange (PEM) fuel cell with integrated energy storage. The integration of these components, namely electrolyser, storage, and fuel cell, is performed at the nanoscale.

A proton battery does not convert produced protons (H⁺) to molecular hydrogen (H₂). Instead, protons serve as active energy carriers. This avoids inefficiencies inherent in the conversion and reconversion of protons to molecular hydrogen.

Proton batteries have shown laboratory performance of up to 1 million charging cycles possibly allowing for decades long operation. Proton batteries are made with inexpensive and abundant materials and are fully recyclable.

Proton batteries use the smallest energy carrier out there—proton—which, unlike lithium, enables unheard-of properties. They charge at extremely high charge rates of up to 4,000 C (<1 second) and typically between 10° C. and 100° C., meaning that charging time is between 0.5 to 6 minutes. Proton batteries are made of non-toxic and non-flammable materials assuring the high safety of the system. Proton batteries can operate in extreme conditions at temperatures between −60 to 70° C., in increased pressure and high humidity environments. For comparison, lithium-ion batteries suffer from an inability to be charged and discharged at low temperatures, especially below 0° C. Certain low-temperature lithium iron phosphate batteries can operate at temperatures between −20 to 60° C.

The so-called “Grotthuss mechanism”, also known as proton-hopping, allows protons diffusion-free movement within the system, resulting in rapid charge and discharge of the battery and a superior lifetime. The mechanism relies on use of an aqueous acidic electrolyte such as sulfuric acid (H₂SO₄), phosphoric acid (H₃PO₄), acetic acid (CH₃COOH), hydrochloric acid (HCl) or citric acid (C₆H₈O₇), amongst others. The best performance is obtained when using phosphoric acid.

The use of aqueous acidic electrolytes allows proton batteries to be safe and non-toxic. At the same time, inexpensive materials of construction and ultra-durable operation over hundreds of thousands of charging and discharging cycles provides economic advantages. In particular, proton batteries are associated with very low cost both from the capital expenditure and levelized cost of storage (LCoS) perspective.

Advantageously, proton battery manufacturing can be done using traditional lithium-ion production lines without the need for re-tooling or with minimal re-tooling requirement.

Proton batteries have properties similar to those of traditional lithium-ion batteries with some unique features of supercapacitors, yet their drawbacks are not as significant as those of either supercapacitors or batteries, placing proton batteries somewhere in the middle between those two technologies.

A generalised comparison is set out in Table 1:

TABLE 1

| Parameter | Supercapacitor | Lithium-ion battery | Proton battery |
|---|---|---|---|
| Charge time | 1 to 10 | 10 to 60 | 1 second to |
| | seconds | minutes | 60 minutes |
| Cycle life | 1 million | 500 to more than | 150,000 to 1 |
| | cycles or | 1,000 cycles | million cycles |
| | 30,000 hours | | or more |
| Service life | 10 to 15 | 3 to 8 | >10 |
| | years | years | years |
| Cell voltage | 2.3 to 2.75 V | 3.6 to 3.7 V | ~1 V |
| Specific energy | Typically, 5 Wh · kg⁻¹ | 100 to 200 Wh · kg⁻¹ | 50 to 100 Wh · kg⁻¹ |
| Specific power | Up to 10,000 W · kg⁻¹ | 1,000 to 3,000 W · kg⁻¹ | Up to 35,000 W · kg⁻¹ |
| Cost | Moderate | High | Low |
| Charge temperature | −40 to 65° C. | 0 to 45° C. | −60 to 70° C. |
| Discharge | −40 to 65° C. | −20 to 60° C. | −60 to 70° C. |
| temperature | | | |
| Safety | Advanced | Moderate | Advanced |
| Recyclability | High | Low | Advanced |
| Material constraints | Low | High | Low |

There is an ongoing need for new chemistries and new efficiencies in proton battery technology.

### SUMMARY OF INVENTION

An object of the present invention is to provide a cathode which, when used in a proton battery, provides improved battery performance.

A further object of the present invention is to alleviate at least one disadvantage associated with the related art.

It is an object of the embodiments described herein to overcome or alleviate at least one of the above noted drawbacks of related art systems or to at least provide a useful alternative to related art systems.

In its broadest aspect the present invention relates to a cathode and method of manufacturing the cathode for a proton battery, the cathode comprising a Prussian blue analogue (PBA) coated on a current collector.

### Prussian Blue Analogues (PBAs)

Prussian blue (Fe₇(CN)₁₈ or more accurately Fe₄[Fe(CN)₆]₃·xH₂O) is a chemical that is well known in the dyestuff industry and is produced by oxidation of ferrous ferrocyanide salts. Other Prussian-blue compounds have one or more iron cations replaced with another metal cation and have a double-perovskite structure with the general chemical formula of AₓFe[Fe(CN)₆]_{1-y}γ_{y}·nH₂O (A: alkali-metal ions; γ: vacancies; 0≤x≤2, 0≤y<1), where the (C≡N)— anions replace the oxide ions of the perovskite structure.

The iron cation can be substituted by a variety of transition metals, including manganese, nickel, cobalt, zinc, copper, chromium, vanadium, and titanium, without breaking down the crystal structure. The resulting series of compounds have similar chemical compositions and crystal structures to AₓFe[Fe(CN)₆]_{1-y}γ_{y}·nH₂O, which are collectively called “Prussian-blue analogues” (PBAs). The person skilled in the art will appreciate that the substitution can result in several different formulae, depending on the metal substituent and its usual oxidation states and whether the PBA is in the oxidised form or reduced form. The prior art literature refers to various options. For example, some of those skilled in the art will represent the general formulae of PBAs as AₓP[R(CN)₆]_{1-y}·nH₂O, where A is an insertion ion, such as potassium or sodium, P and R are transition metals (the R site often occupied by Fe) and Y is the number of [R(CN)₆] vacancies. Other persons skilled in the art will represent the general formula of PBAs as AₓP[R(CN)₆]. In yet another representation the general formula of PBAs has been represented as AM[M′(CN)₆]·xH₂O wherein usually A=Li, Na or K, M, M′=transition metal, where typically M′=Fe, and sometimes M=M′. PBAs are also often referred to as hexacyanoferrates if M′=Fe, or hexacyanometallates if M′=other transition metal.

Preferably the PBA of a cathode according to the present invention has the general formula M^{III}₄[Fe^{II}(CN)₆]₃ wherein M is a metal other than Fe. In another preferred embodiment the PBA of a cathode according to the present invention has the formula Cu₃[M(CN)₆]₂ with M=Fe, Co, or Ir.

In a particularly preferred embodiment the PBA is copper hexacyanoferrate Cu[Fe(CN)₆]·XH₂O, potassium copper hexacyanoferrate K₂Cu[Fe(CN)₆] or manganese hexacyanoferrate. In particular, copper hexacyanoferrate has demonstrated excellent proton intercalation and storage capabilities. The PBA of the present invention may be prepared by any known technique. For example, copper hexacyanoferrate may be prepared by adding an excess of CuSO₄·5H₂O solution to K₃Fe^{II}(CN)₆.

Where used herein the term “PBA” is also intended to include pre-protonated PBAs. Without wishing to be bound by theory, abundant protons in a pre-protonated PBA can improve capacity and cyclic stability of electrode material by mitigating loss of capacity, particularly at the early part of charging or discharging.

However, many other PBAs are suitable for use in the cathode of the present invention including PBAs that include aluminium, nickel, magnesium, lithium, sodium, or other metals. However, it is important to note that water soluble PBAs such as alkali metal (sodium, potassium, lithium) ferrocyanides are not usable in a proton battery that have aqueous electrolytes.

In a first aspect of embodiments described herein there is provided a cathode for a proton battery having a first layer comprised of a PBA, battery-grade carbon nanoparticles and a binder, and a second layer comprising a current collector.

### Carbon Nanoparticles

The term “battery-grade” when applied to carbon is a well-known term in battery technology. Generally, battery-grade carbon has very high purity (>99% carbon content), surface area and electrical conductivity. Battery-grade carbon also has very low metal impurities, typically iron levels of less than 5 parts per million (ppm), copper, nickel, cobalt and zinc in the order of the low ppm to ppb range, preferably less than 5 ppm. These impurities may have a negative impact on the battery lifetime, although this is less of a concern in proton batteries that operate at lower voltages compared to their lithium counterparts.

Typically, the battery-grade carbon nanoparticles comprise carbon black (preferably acetylene black), graphene or carbon nanotubules. The nanoparticles are typically 10 to 50 nm in size.

### Binder

The PBA and battery-grade carbon nanoparticles are typically combined with a non-water-soluble binder. The binders must hold the carbon nanoparticles and PBA together and assist in adhering them to the current collector. The binder also aids in dispersion to form a uniform slurry for application to the current collector and remain stable in the harsh battery environment where many reactions occur.

Suitable binders for use in the present invention include fluoropolymer polyvinylidene fluoride (PVDF), which consists of a carbon backbone chain with multiple connected C—F bonds, silicate binders such as sodium silicate binders and polycarbonate binders. The nature of the solvent in which the PVDF is dissolved is also important in determining the characteristics of the first layer. PVDF is not soluble in most standard organic solvents. Preferably the binder of the present invention includes PVDF dissolved in a solvent such as N-methyl-2-pyrrolidone (NMP), dimethyl formamide (DMF) or dihydrolevoglucosenone (Cyrene™—Cyrene is a trademark of Circa Group). Cyrene™ solvent is particularly preferred due to its low toxicity and environmental impact compared to NMP or DMF, despite being comparatively expensive.

Notably, water soluble binders are generally unsuitable for use in the cathode of the present invention where an aqueous electrolyte is used. However, they may be suitable for use with non-aqueous electrolytes or solid-state batteries.

### Current Collector

The cathode current collector is used as a support for the first layer, to collect electrical current generated at the cathode to form a larger output current to supply an exterior circuit. The existence of the current collector reduces the internal resistance of the battery, improves current efficiency, cycle stability and rate performance. The current collector of the present invention may be any suitable conductive electrode support, such as metal foil, metal foam, polymer film and paper coated metal substrates. Particularly preferred are metal foils such as titanium foil, copper foil, aluminium foil, and carbon-based materials including carbon paper comprising carbon microfibres.

### Battery Structure

In another aspect of embodiments described herein there is provided a proton battery comprising;
a cathode having a first layer comprised of PBA and battery-grade carbon material, and a second layer comprising a current collector,
a separator,
an anode, and
electrolyte.

Preferably the selection of electrode materials provides (i) high capacity, (ii) excellent rate performance, (iii) wide operating voltage range, (iv) chemical stability, (v) non-toxic nature, green and pollution free and (vi) substantially recyclable.

### Anode

The anode may be any suitable anode for a proton battery such as platinum on carbon (Pt/C) anodes or “activated” carbon anodes that have previously been used for conventional Prussian blue based batteries. Tungsten trioxide (WO₃) is an alternative anode material, as is carbon-coated titanium foil.

Conducting polymers and redox polymers are other potential anode options and would include, for example, PEDOT and other thiophene derivatives.

### Separator

The separator in a battery is typically a porous polymer membrane that acts as a blocking interface between electrodes, while allowing proton transport between them. Preferably the material of the separator is stable, safe, and sustainable and does not diminish battery performance. The separator may be, for example, a traditional proton exchange membrane such as Nafion™ (Nafion is a trademark of DuPont.) Preferred Nafion™ membranes are N-112, N-115, N-117, NE-1135 or NE-1110. Other suitable separator membrane materials include Pemion™ (Pemion is a trademark of Ionomr Innovations) or per-fluorinated-sulfonic-acid (PFSA) membranes such as those manufactured by Fumatech BWT GmbH, including Fumatech's FS-960-RF, FS-990-PK, F-10100, and F10150-PTFE.

In another aspect of embodiments described herein there is provided a method of manufacturing a cathode for a proton battery comprising the steps of:
forming a slurry comprising PBA, battery-grade carbon nanoparticles and binder, and
coating a layer of the slurry onto a cathode current collector to form the cathode, and optionally,
compressing the coating layer,
drying the coating layer,
cutting the cathode to a desired shape.

In another aspect of embodiments described herein there is provided a method of manufacturing a proton battery comprising the step of combining a cathode according to the present invention with a separator, an anode and electrolyte.

It is also possible to prepare a solid-state embodiment of the proton battery by mixing a proton conducting material like Nafion™ into the cathode and anode materials as well as using a proton conducting separator. It should be noted that such device would not be water-free but solid none the less.

Other aspects and preferred forms are disclosed in the specification and/or defined in the appended claims, forming a part of the description of the invention.

In essence, embodiments of the present invention stem from the realization that use of PBAs, particularly certain PBAs, provides improved cathode and battery performance when compared with equivalent Prussian blue based cathodes and batteries.

Advantages provided by the present invention comprise the following:
economy of manufacture due to inexpensive and non-toxic materials,
ultra-fast charging rates and ultra-long life cycle,
maintenance is comparable to traditional battery systems,
capital expenditure is spread over hundreds of thousands of cycles (compared with 1,000 cycles for lithium-ion batteries), and
overall efficiency up to 97% (compared with <93% for lithium-ion batteries).

Potential applications for cathodes and batteries according to the present invention include the following:
car batteries,
batteries for vehicles in constant use, requiring fast charging such as forklifts and mine vehicles,
energy buffers for EV charging stations to reduce the burden imposed by charging on a grid,
stationary and grid-firming battery systems for renewable energy systems (to enable time shifting of intermittent renewables by balancing load,
dual battery packs, i.e., a proton battery with a lithium-ion battery,
home energy storage,
remote energy storage,
micro-grid energy storage, and
support systems in mobile applications.

Further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

Further disclosure, objects, advantages, and aspects of preferred and other embodiments of the present application may be better understood by those skilled in the relevant art by reference to the following description of embodiments taken in conjunction with the accompanying drawings, which are given by way of illustration only, and thus are not limitative of the disclosure herein, and in which:

FIG. 1 is a flow diagram indicating the steps for manufacture of a cathode according to one embodiment of the present invention. FIG. 1A depicts the steps leading to creation of the solid mixture. FIG. 1B depicts the steps for preparation of the slurry and its application to a current collector.

FIG. 2 illustrates a simple diagram of a proton battery of the type suitable for use with the cathode of the present invention in discharging mode (FIG. 1A) and in charging mode (FIG. 1B).

### DETAILED DESCRIPTION

The cathode according to the present invention may be based on a PBA such as copper ferricyanide or manganese ferricyanide, mixed with nanoparticulate acetylene black, graphene, carbon nanotubes, or other battery-grade carbon material, typically in the presence of a binder.

These three components are mixed to form a slurry, then applied wet to a cathode support. The cathode can then be dried and cut to a suitable shape. It may then be packaged with an anode, separator, and electrolyte to form a proton battery.

A traditional non-water-soluble battery binder is suitable, such as polyvinylidene fluoride (PVDF) which is widely used as a binder in lithium-ion batteries dissolved in N-methyl-2-pyrrolidone (NMP), dimethyl formamide (DMF), Cyrene™ or another suitable solvent.

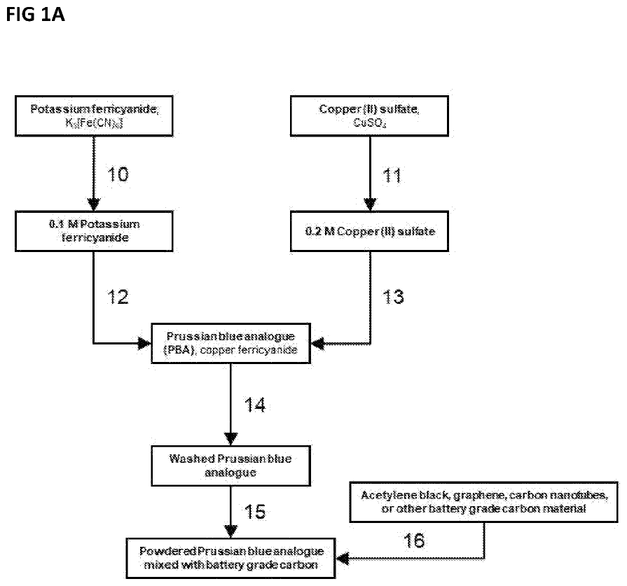

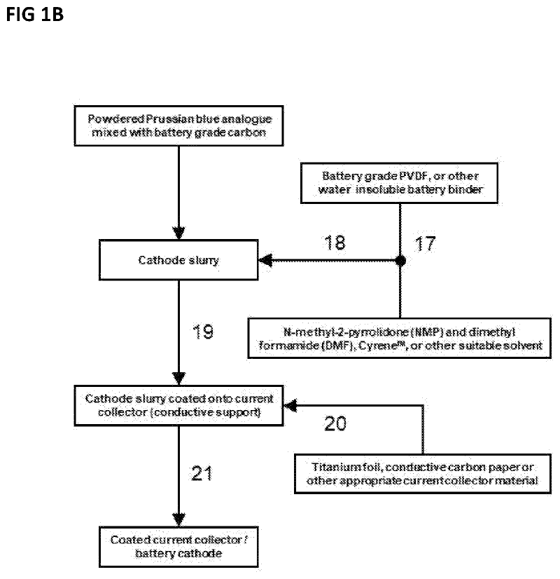

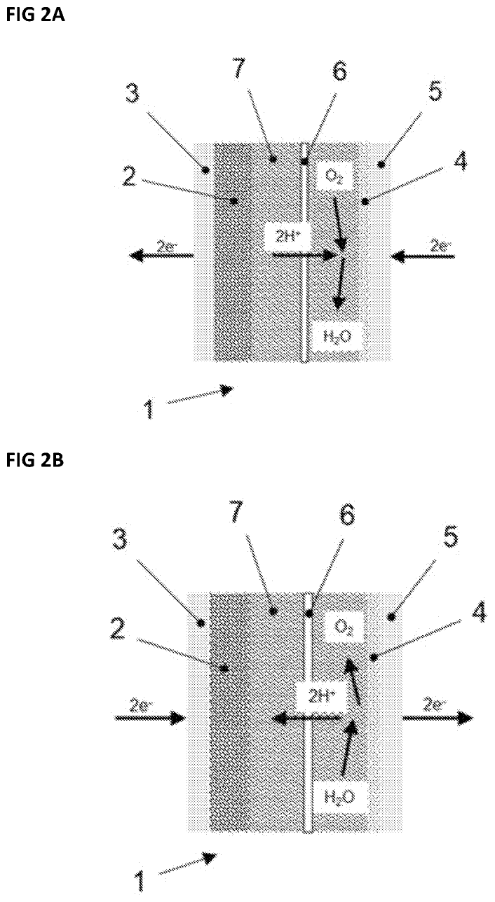

This is depicted in more detail in FIG. 1, which is a flow diagram indicating the steps for manufacture of a cathode according to a preferred embodiment of the present invention. FIG. 2A depicts the steps leading to creation of the solid mixture. FIG. 2A depicts the steps for preparation of the slurry and its application to a current collector.

While FIG. 1 illustrates the use of copper ferricyanide as a PBA, it will be readily appreciated that many other PBAs could be synthesised and used in the method depicted including PBAs that comprise aluminium, nickel, magnesium, lithium, sodium, or other metals. However, it is important to note that water soluble PBAs such as alkali metal (sodium, potassium, lithium) ferrocyanides are not usable in a proton battery that have aqueous electrolytes.

### Preparation of the Solid Mixture

In one preferred embodiment of the present invention as depicted in FIG. 1A a 0.1M solution can be prepared by dissolving potassium ferricyanide in deionised water (10) and forming an 0.2M copper (II) sulphate solution by dissolving copper(II) sulphate in deionised water (11). The copper(II) sulphate solution (13) can then be added dropwise to the potassium ferricyanide solution (12) with stirring over a period of 8 hours (13) to form PBA nanoparticles.

The PBA nanoparticles may be filtered off the solution using a centrifuge followed by extensive washing (in excess of three times) with deionized water (14). As an alternative to a centrifuge, filter paper or another similar filtration technique could be used. The filtrand may be dried in a vacuum oven for 8 hours until dry. Alternatively, drying may be carried out over a hotplate or other suitable drying device.

The dried PBA is then reduced to a powder using a mortar and pestle (15) or any convenient pulverising means. The powdered PBA is then mixed with battery grade carbon material (16).

FIG. 1B depicts the step of mixing (17) battery grade PVDF (or alternatively, another water insoluble battery binder) with N-methyl-2-pyrrolidone (NMP) and dimethyl formamide (DMF), Cyrene™, or some other suitable solvent. This is then mixed (18) with the powdered PBA to form a cathode slurry.

A doctor blade or other suitable device can be used to coat the cathode slurry (19) onto conductive support made of titanium (20). As an alternative to the doctor blade, other wet coating techniques could be used. Furthermore, as an alternative to titanium, the support can comprise a carbon mat, or some other conductive support (current collector).

The cathode thus prepared, can be dried (21), for example in a vacuum oven, hotplate or other drying means. In another embodiment of the method, compression may be applied prior to drying to compress the cathode slurry. The cathode is then ready for cutting and assembly in a cell.

Except for the limited drying and compression, the method depicted in FIG. 2A and FIG. 2B can be carried out at room temperature and pressure and does not require an inert atmosphere.

The selection of a suitable conductive cathode support or current collector is driven by its conductivity but also its ability to withstand hundreds of thousands of charging and discharging cycles, prolonged battery life, and the ability to be chemically inert in acidic conditions.

The separators may be a traditional proton exchange membranes such as Nafion™ which provides excellent performance due to its proton-conducting properties. In one embodiment, a glass fiber separator was used instead of a proton exchange membrane, allowing for cost reduction compared to Nafion™ membranes; however, this combination exhibited lower battery performance. Other membranes, including Pemion™ or per-fluorinated-sulfonic-acid (PFSA) membranes have also been used. The present invention can work with various other proton conducting membranes that are suitable for operation in acidic electrolyte conditions. Cation exchange membranes might also be used in the proton battery of the present invention.

A typical proton battery for use with a cathode according to the present invention is depicted in FIG. 2. The proton battery 1 comprises a cathode according to the present invention comprising a first catalyst layer 2 and a current collector layer 3. The anode with catalyst layer 4 is typically made of materials such as tungsten trioxide or Pt/C deposited onto current collector layer 5. Between the two electrodes is a separator 6 (e.g., Nafion™) and aqueous acidic electrolyte 7. The arrows indicate the flow of protons across the separator as the proton battery 1 charges and discharges.

The present invention is further described with reference to the following non-limiting examples.

### Example 1—Preparation of a Cathode

A cathode slurry was prepared by mixing copper ferricyanide with carbon black nanoparticles and PVDF binder in a mass ratio of 6:3:1. The slurry was coated on 0.1 mm thick titanium foil current collectors. The active mass of the cathode was 23 g·m⁻². Higher active mass loadings can be obtained for example, by using a slurry having a mass ratio of 12:3:5 for copper hexacyanoferrate, carbon black, and PVDF. The relative capacity for the battery was 53 mA·g⁻¹.

The cathode slurry was wet coated onto cathode current collector using a doctor blade to obtain a layer of uniform thickness. The cathode was then subjected to compression of the coated layer, followed by drying and cutting the cathode to the desired shape.

The cathode was then packaged with an anode, separator, and electrolyte to form a proton battery.

Two types of proton battery cells have been manufactured according to the steps set out above—(i) small-scale test coin cells, and (ii) pouch cells. Cylindrical proton battery cells, battery packs and battery systems are anticipated as being with the scope of the present invention.

### Example 2—Synthesis of a Copper PBA

A PBA suitable for use in the cathode of the present invention, was synthesized by adding 0.2 M CuSO₄·5H2O solution dropwise into an equivalent volume of 0.1 M K₃Fe^{II}(CN)₆ while continuously stirring the solution. The dropwise addition was carried out manually using a pipette, but could alternatively been carried out using an automatic dropwise dispenser or other suitable technique known in the art.

The copper sulphate pentahydrate was added in excess to K₃[Fe^{II}(CN)₆]₃ to ensure that all the K₃[Fe^{II}(CN)₆]3 is converted.

Reaction took place over 8 hours until copper hexacyanoferrate crystals formed and the reaction was complete. The crystalline precipitate was washed with deionized water three times then dried in a vacuum oven at elevated temperature for over 8 hours until thoroughly dried.

Water and ethanol could alternatively be used for washing. As another alternative, centrifugation and sonication or any other technique known in the art could be used to separate the precipitate and solution. In the majority of cases, a simple paper filter may be used to collect the precipitate of copper hexacyanoferrate.

### Anode

Platinum on carbon (Pt/C) anodes or “activated” carbon anodes are suitable for proton battery cells. The counter electrode for performance measurement of cathodes produced according to the present invention comprised 0.1 mm thick titanium foil coated with activated carbon, carbon black, and PTFE or PVDF binder in the mass ratio of 7:2:1, respectively. The mass loading for the counter electrode varied between 200 to 400 g·m⁻².

For the actual proton battery setup, a tungsten trioxide (WO₃) anode was used to obtain a proton battery full cell with an average voltage in excess of 1 V. Tungsten trioxide (WO₃) is an anode material that appears to give slightly higher battery voltage. For obtaining better electrical conductivity, slight oxygen deficiency (i.e., WO_{2.96} or similar) is an option.

An alternative anode setup relied on a platinum on carbon (Pt/C) electrode made of a 9:1 mass ratio of 20% Pt/C and PVDF, respectively, coated onto a current collector.

Conducting polymers and redox polymers are other potential non-precious anode options. In particular, the polyaniline group may be suitable because their redox reaction involves proton shuffling under acidic conditions (where it is also most stable). Poly(3,4-ethylenedioxythiophene (PEDOT) and other thiophene derivatives are known for their stability and have been used to replace Pt/C electrodes in various types of solar-cells.

Conducting polymers also offer the possibility of tuning the potential of the anode. The same is the case for redox polymers (which are non-conducting by nature, but contain redox active groups in the repeat unit which allows charge hopping to occur). Redox polymers have been researched for potential fast-charging battery application. Blends of conducting- and redox polymers have been made to obtain better conductivity and maintain the distinct redox behaviour of the redox polymer (see international patent publication WO 2012/121417).

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures.

When a Markush group or other grouping is used herein, all individual members of the group and all combinations and sub-combinations possible of the group members are intended to be individually included in the disclosure. Every combination of components described or exemplified herein can be used to practice the invention, unless otherwise stated.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. The broad term “comprising” is intended to encompass the narrower “consisting essentially of” and the even narrower “consisting of.” Thus, in any recitation herein of a phrase “comprising one or more claim element” (e.g., “comprising A), the phrase is intended to encompass the narrower, for example, “consisting essentially of A” and “consisting of A” Thus, the broader word “comprising” is intended to provide specific support in each use herein for either “consisting essentially of” or “consisting of.” The invention illustratively described herein suitably may be practiced in the absence of any element or elements, limitation or limitations which is not specifically disclosed herein.

One of ordinary skill in the art will appreciate that materials and methods, other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by examples, preferred embodiments and optional features, modification and variation of the concepts herein disclosed may be resorted to by those skilled in the art, and that such modifications and variations are considered to be within the scope of this invention as defined by the appended claims.

Each reference cited herein is incorporated in its entirety. Such reference may provide sources of materials; alternative materials, details of methods, as well as additional uses of the invention.

1. A cathode for a proton battery, the cathode comprising a Prussian blue analogue (PBA) coated on a current collector.

2. A cathode for a proton battery according to claim 1 wherein the PBA is formed from Prussian blue having an Fe cation substituted by a transition metal cation.

3. A cathode for a proton battery according to claim 1 wherein the PBA is formed from Prussian blue having one or more iron cations replaced with a transition metal cation, and having a double-perovskite structure.

4. A cathode for a proton battery according to claim 1 wherein the PBA has the general formula M^{III}₄[Fe^{II}(CN)₆]₃ wherein M is a metal other than Fe or the general formula Cu₃[M(CN)₆]₂ wherein M=Fe, Co, or Ir.

5. A cathode for proton battery according to claim 1 wherein the PBA is copper hexacyanoferrate or manganese hexacyanoferrate

6. A cathode for a proton battery according to claim 1 having a first layer comprised of PBA and battery-grade carbon nanoparticles, coated on a second layer comprising a current collector.

7. A cathode for a proton battery according to claim 1 wherein the PBA is combined with battery-grade carbon nanoparticles and a non-water-soluble binder.

8. A cathode for a proton battery according to claim 1 wherein the ratio of PBA:carbon nanoparticles:binder is between 6:3:1 and 12:3:5.

9. A cathode for a proton battery according to claim 7 wherein the battery grade carbon is in the form of nanoparticles of 10 to 50 nm in size and comprises greater than 99% carbon, and less than 5 ppm of, individually, iron, copper, nickel, cobalt and zinc.

10. A cathode for a proton battery according to claim 7 wherein the non-water-soluble binder comprises polyvinylidene fluoride dissolved in a solvent chosen from N-methyl-2-pyrrolidone, dimethyl formamide or dihydrolevoglucosenone.

11. A cathode for a proton battery according to claim 7 wherein the current collector is chosen from the group comprising metal foil, metal foam, polymer film and paper coated metal substrates.

12. A proton battery comprising:
a cathode according to any one of the previous claims,
a separator,
an anode, and
an electrolyte.

13. A proton battery according to claim 11 having an anode chosen from the group comprising platinum on carbon, activated carbon, tungsten trioxide, carbon-coated titanium foil, conducting polymers and redox polymers.

14. A method of manufacturing a cathode for the proton battery of claim 1, the method comprising the steps of:
forming a slurry comprising PBA, battery-grade carbon nanoparticles and binder, and
coating a layer of the slurry onto a cathode current collector to form the cathode.

15. A method of manufacturing a cathode according to claim 14, the method further including the steps of:
compressing the coating layer,
drying the coating layer, and
cutting the cathode to a desired shape.

16. A proton battery comprising a cathode according to claim 1.
